(19) United States
(12) Patent Application Publication
(10) Pub. No.: US 2007/0203435 A1
(43) Pub. Date: Aug. 30, 2007

(54) System And Method For Gait Synchronized Vibratory Stimulation Of The Feet

(76) Inventor: Peter Novak, Jamaica Plain, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/594,407

(22) PCT Filed: Mar. 28, 2005
(86) PCT No.: PCT/US05/10318

§ 371 Date: Sep. 26, 2006

Related U.S. Application Data
(60) Provisional application No. 60/556,665, filed on Mar. 26, 2004.

(51) Int. Cl. A61H 1/00

(52) U.S. Cl. 601/70; 601/46

(57) ABSTRACT

A device and method for stimulating a foot of a subject based on ambulatory feedback can impact various characteristics of the subject's gait. The device may include a pressure sensor, a switch or controller, and a vibrational stimulator. The switch or controller actuates the stimulator based on feedback from the pressure sensor. The controller can include algorithms to provide stimulation based on the pressure sensor input, as well as record data related to characteristics such as step or stride interval, step characteristics and other ambulatory-related information.

### CROSS REFERENCE TO RELATED APPLICATIONS

This application claims the benefit of U.S. Provisional Patent Application No. 60/556,665, filed Mar. 26, 2004, titled “A Device for Gait Synthesized Vibratory Stimulation of the Feet,” the entire contents of which are hereby incorporated herein by reference.

### STATEMENT REGARDING FEDERALLY SPONSORED RESEARCH OR DEVELOPMENT

N/A

### BACKGROUND OF THE INVENTION

1. Field of the Invention

This invention is generally related to foot stimulation devices and methods and relates more particularly to a device and method for stimulating foot mechanoreceptors in synchrony with the phase of the gait.

2. Description of Related Art

Increased stride-to-stride variability has been associated with neurological gait abnormalities as well as falls. Previous studies suggested that alterations of the proprioceptive feedback using vibratory stimulation might affect the gait.

Somatosensory feedback plays a critical role in the control of movement, balance and gait. Alterations of the proprioceptive feedback can alter balance, posture and/or gait. For example, vibratory stimulation of muscles facilitates voluntary muscle contractions. Vibratory stimulation of the foot elicits postural responses that control maintenance of the erect posture. Vibration of the feet with noise-like vibration improves motor control in humans by reducing postural sway. Vibrators applied to calf muscles or with galvanic vestibular stimulation enhances recovery of postural functions in post stroke patients In healthy volunteers, plantar stimulation results in a body tilt, affects the postural adjustment to upright posture and may improve balance. Vibratory stimulation of the leg muscles facilitates voluntary muscle contractions. Increase in walking speed is observed during continuous vibration of the neck and hamstring muscles. Moreover, vibration of the biceps femoris tendon affects the interlimb coordination.

Sensory stimulation has been explored in treatment of several neurological conditions associated with movement abnormalities. For example, vibratory stimulation of muscle tendons can reduce parkinsonian tremor. Vibrators applied on the calf muscles facilitate recovery of postural control in post-stroke patients. Plantar stimulation improves the rightward orientation in patients with spatial neglect after the right hemispheric stroke.

The shortcoming of commonly used approaches is that they do not take into account the phase of the gait. Foot proprioceptors are activated upon a foot step and deactivated upon elevation of the foot. As such, a device that delivers the vibration stimulus at a particular phase of the gait could enhance the beneficial effect of vibratory stimulation upon the gait.

In a particular case, short shuffling steps, reduced walking speed and increased stride variability are the hallmarks of abnormal gait in Parkinson's disease (PD). Abnormal proprioception and impaired kinesthesia may contribute to the parkinsonian gait. PD patients have reduced sensation on the plantar feet, impaired joint position sense, movement perception and movement accuracy. Neurophysiological and functional imaging studies have shown that sensory processing is impaired at a central level.

In PD, abnormal proprioception may result from an inadequate integration of sensory inputs at the striatum, or from a defective proprioceptive feedback. Clinically, the role of abnormal proprioceptive feedback in generation of PD gait pattern remains unclear. The plantar mechanoreceptors that mediate postural adjustment are activated by the foot pressure during the touch down and stance phases of the step, and can be also activated by the vibration stimulation at 70 Hz.

### BRIEF SUMMARY OF THE INVENTION

In accordance with the present invention, a vibration stimulation of peripheral mechanoreceptors during particular portions of a gait is provided. The stimulation enhances sensory feedback, and facilitates proprioceptive processing in PD, for example. A device according to the present invention delivers vibration stimulation to the soles during an interval that includes a portion of a stance part of a step. The stimulation is may be selectively omitted during a swing phase of each step. Operation of the device may be achieved using a simple closed-loop control. In accordance with the present invention, proprioceptive input during a gait is enhanced using step-synchronized vibration stimulation in healthy and PD subjects.

In accordance with the present invention, a device and method delivers a vibratory stimulus that is synchronized with the phase of the gait. The device senses the foot pressure at the heel, and upon satisfying predetermined conditions such as, for example, a certain pressure level, delivers vibration stimulus to the forefoot. A vibrator stimulator such as an electric motor with an eccentric load or a piezo-based vibrator can be used.

In one embodiment, the device consists of a footswitch that turns on the vibration motor upon the foot step. A micro switch and miniature vibrator motor with eccentric load, i.e., a “pager motor,” (Namiki, Japan, diameter 4 mm) may be used and are implantable inside the shoes. The device may be embodied into a plastic enclosure of the size 2.5×2.5×0.8 cm. Typically, two or three units are installed into one shoe, one below the heel and one to two unites below the fore heel or fore foot.

The whole unit is inserted into the modified shoes. It is very simple in use and non-invasive. The effectiveness of vibratory stimulation depends upon the phase of the gait, and the stimulation becomes more effective during a swing phase as compared to a stance phase.

The advantage of the invented device is that the vibratory stimulation is synchronized with the phase of the gait. The pulsatile stimulation reduces habituation of the mechanoreceptors and prolongs the battery life.

According to one embodiment, the device consists of a footswitch and vibrator motor. The device in this embodiment is simple and easy to manufacture in large quantities.

According to another embodiment, the device accommodates a timer that turns off the vibration after predefined delay to prevent continuous stimulation when the subject stands without movement or sits. According to an advantage of the invention, control is performed by using pressure sensors to obtain an output signal activated by the pressure at the sole. This pressure signal can be processed by a microcontroller/microprocessor, sampled typically using an analog/digital converter. After processing, the microprocessor controls the vibrator motor, typically via a digital/analog converter or other interface.

A microcontroller/microprocessor based system enables considerable flexibility in control of the desired vibratory stimulus in terms of gait phase, stimulus duration and intensity as well as interrelation between two stimuli when more than one vibratory device is used. A variety of stimulatory patterns can be employed such as a preemptive stimulation, typically applied a short time before the foot touches the floor, to facilitate response of the locomotory apparatus. Other patterns include stimulation of the fore heel that is phase-shifted from below-heel stimulation and phase-correlated stimulation of a contralateral foot portion.

The present invention features synchronization of the vibratory stimulation with the phase of the gait. Accordingly, treatment of variety of gait disorders such as primary gait disorders, gait disorders associated with systemic illness, gait disorders associated with stroke, Parkinson's disease, dementia, multiple sclerosis, aging, etc., may be treated.

The invention may be battery operated and accommodate recharging/replacement of the batteries. The invention may be waterproof, and suitable for outdoor use. Advanced microprocessors/microcontrollers may be used to obtain greater efficiency and control, permitting activities such as data collection and analysis.

The device can be made to be extremely cost effective. The estimated wholesale price of one unit is on the order of several dollars. This cost can be substantially reduced if built in large quantities. The potential market is enormous, with the estimated number of subjects that might benefit from the device being on the order of millions in the U.S. alone.

### BRIEF DESCRIPTION OF THE SEVERAL VIEWS OF THE DRAWINGS

The invention is described in greater detail below with reference to the accompanying drawings, in which:

FIG. 1 is a block diagram of a device according to the present invention;

FIGS. 2A-2C are diagrams of a device and placement and operation embodiments;

FIGS. 3A and 3B are graphs showing stride intervals in a healthy control subject;

FIG. 4 is a graph showing standard deviation of stride intervals during on and off periods of vibration in a Parkinson's disease patient;

FIG. 5 is a plan view of an exemplary embodiment of the present invention;

FIG. 6 is a cross-sectional cutaway view of an exemplary embodiment of the present invention;

FIG. 7 is a graph showing stride intervals in test subject without foot stimulus; and

FIG. 8 is a graph showing stride intervals in a test subject with foot stimulus.

### DETAILED DESCRIPTION OF THE INVENTION

The present invention is the result of a study to assess the effect of vibratory stimulation of the soles of a subject's feet that is synchronized with their step. One variable studied was that of gait variability. Step-synchronized vibratory stimulation (SSV) of the soles was evaluated in 7 healthy subjects (4 females and 3 males, age range 28-53 years) during self-paced normal walk. Stride-to-stride interval was measured using force foot-switches connected to a wearable computer. The device for SSV was mounted into shoe insoles. The vibratory device operates in the closed-loop mode and it is activated upon heel strike and turned off during a push off phase. One observed result is that SSV decreased the standard deviation (p<0.014) and coefficient of variation (p<0.016) of the gait. No statistical difference in other monitored parameters such as walking distance, average speed and step duration, average step length was observed. The observed results indicate that the closed-loop step-synchronized vibratory stimulation of the soles reduced the stride-to-stride variability in healthy subjects. Since the stride-to-stride variability is positively correlated with gait abnormalities, the present invention is apparently useful for treatment of gait disorders.

To assess the effects of vibratory stimulation on gait, a wearable vibratory device that can be used during normal walking was provided. The mechanoreceptors of the soles that mediate postural adjustment are sensitive to vibratory stimulation and the pressure created during the stance phase of the step activates these receptors. The device delivers a vibratory stimulus to the sole while the foot is in contact with the floor.

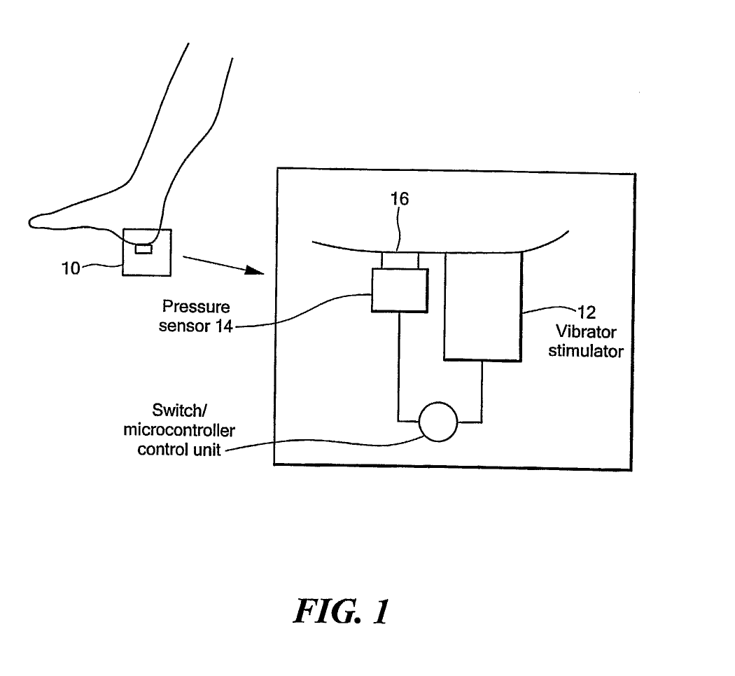

The wearable, battery operated device in an exemplary embodiment of the present invention gives a vibratory stimulus synchronized with stance phase of the gait was designed. FIG. 1 illustrates vibratory device 10, which senses pressure at the sole and turns on vibration upon heel touch and turns off upon push off during swing phase. Device 10 is mounted in the shoe insoles that can be inserted into regular shoes. The stimulus intensity was empirically set to a near-threshold level.

The subjects felt the stimulation slightly while standing. Upon walking, the subjects sensed vibration typically only when specifically asked to focus on vibratory sensation at their feet.

Subjects were asked to walk for 6 minutes at their normal speed in a hallway with a length of 73 m and a width of 1.7 m with the device on and 6 minutes with the device turned off. To reduce expectation bias and to check subjective level of vibratory stimulation, subjects were allowed to walk for few steps with the device on and off before the gait recordings.

The gait characteristics were recorded using a gait monitoring system (Gait Jogger, JAS Research Inc., MA) connected to the foot switches (B&L Engineering, Inc., CA) using four force sensors at each foot. The gait signal was sampled at 200 Hz using a 12-bit analog/digital converter and recorded on a portable microcontroller-based storage device. The raw data were transferred to a personal computer and processed off-line. The heel-touch was detected for each step forming stride-to-stride interval time series. Values exceeding two standard deviations were excluded. The following parameters were further analyzed: average step length, walking distance, average speed, standard deviation (SD) and coefficient of variation (CV, 100×sd/mean step duration) of the stride-to-stride interval. CV is an index of variability normalized to a subject's mean step length. For statistical analysis an average SD of both legs was taken. Statistical analysis was performed for repeated measures with vibration (off versus on) as an independent variable.

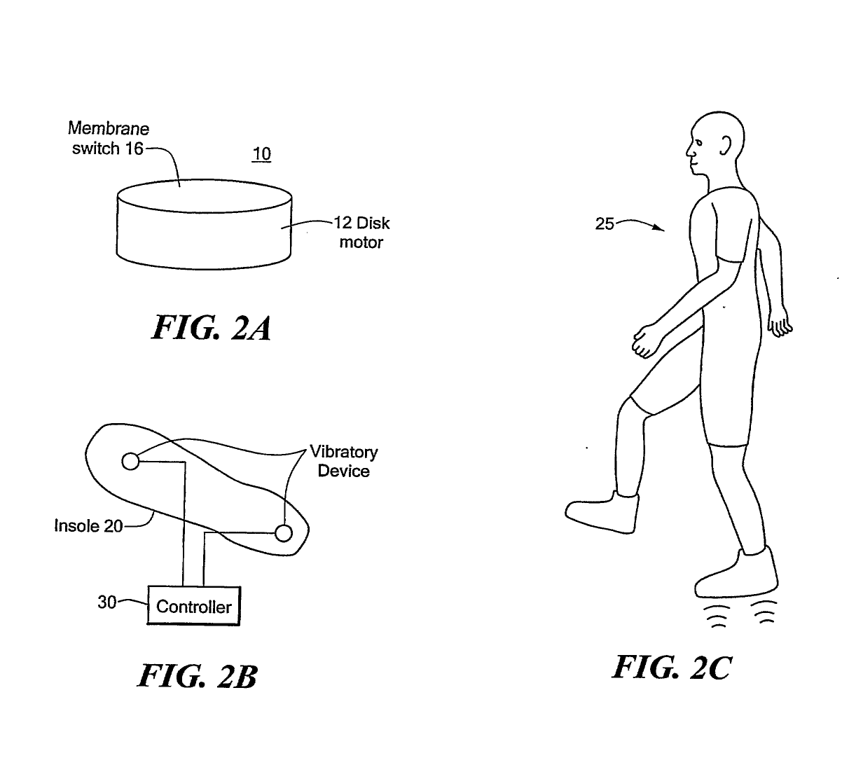

Device 10 of FIG. 1 includes a vibrator or stimulator 12, which can be a miniature vibrating disk motor such as Optec 2890W11 (OPTEC Co. Ltd., Japan), vibrating at a frequency of 70 Hz and operating at 1.3 V. A foot pressure sensor 14 that provides a feedback to the vibratory device may include a membrane switch 16 that switches with the application of a force of approximately 350 g. The foot sensor may be glued to a top of the vibration motor enclosure. The whole unit is embedded in a plastic foam insole 20 of FIG. 2B. For each insole, two vibratory units were used, below the heel and below the forefoot. The results with the device operating in a simple closed loop mode were observed and analyzed. Device 10 provides all necessary input/output signals for interfacing with a real-time microcontroller 30, that might deliver the vibratory stimulation in a variety of preprogrammed patterns and be worn about the body. The patterns include: 1 heel sensor stimulates same heel and/or forefoot with or without delay; and 2 heel sensors stimulate opposite foot.

Referring to FIG. 2A-C, Vibratory device 10 includes a vibration disk motor 12, having a diameter of 18 mm. A membrane switch 16 is glued on the top of motor 12 with a resulting thickness of approximately 5.0 mm and a weight of approximately 5 grams. An insole with vibration device 10 built in is provided in an exemplary embodiment of the present invention.

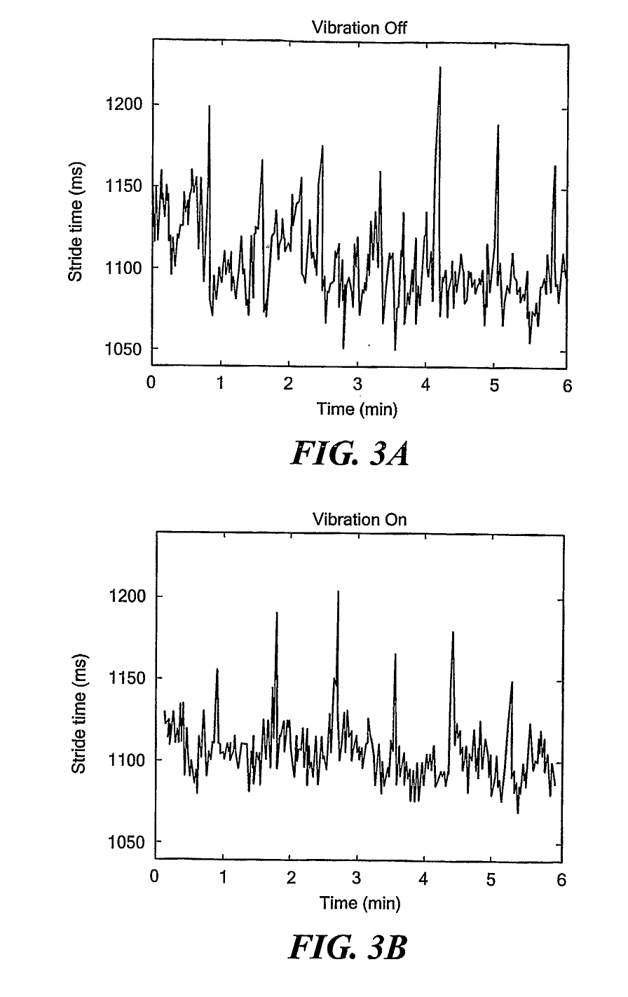

The device was well tolerated by the subjects 25 (FIG. 2A). Six minutes of walking periods included straight segments and typically 6-7 turns of 180 degree. FIG. 3 shows an example of the stride-to-stride intervals with the vibratory stimulation on and off during walking in one healthy subject. The stride-to-stride interval data obtained from a 41-year-old control subject during vibratory stimulation off (SD 21.46 ms) and on (SD 15.79 ms) is illustrated. The spikes in the stride intervals correspond to turns.

The standard deviation decreased during walking with vibration. Gait characteristics during vibration on and off are summarized in the Table 1 below.

TABLE 1
Descriptive statistic.

| | Vibration | | |
|---|---|---|---|
| Gait parameters | Off | On | P |
| Walking distance (m) | 525.8 ± 59.7 | 524.1 ± 55.32 | NS |
| Mean gait speed (m/s) | 1.46 ± 0.16 | 1.45 ± 0.15 | NS |
| Mean step length (m) | 1.71 ± 0.48 | 1.5 ± 0.1 | NS |
| SD (ms) | 22.92 ± 5.03 | 19 ± 0.46 | 0.014 |
| CV (%) | 2.2 ± 0.63 | 1.9 ± 0.46 | 0.016 |
| Step duration (ms) | 1024.45 ± 33.06 | 1020.86 ± 85.17 | NS |

NS = not significant.

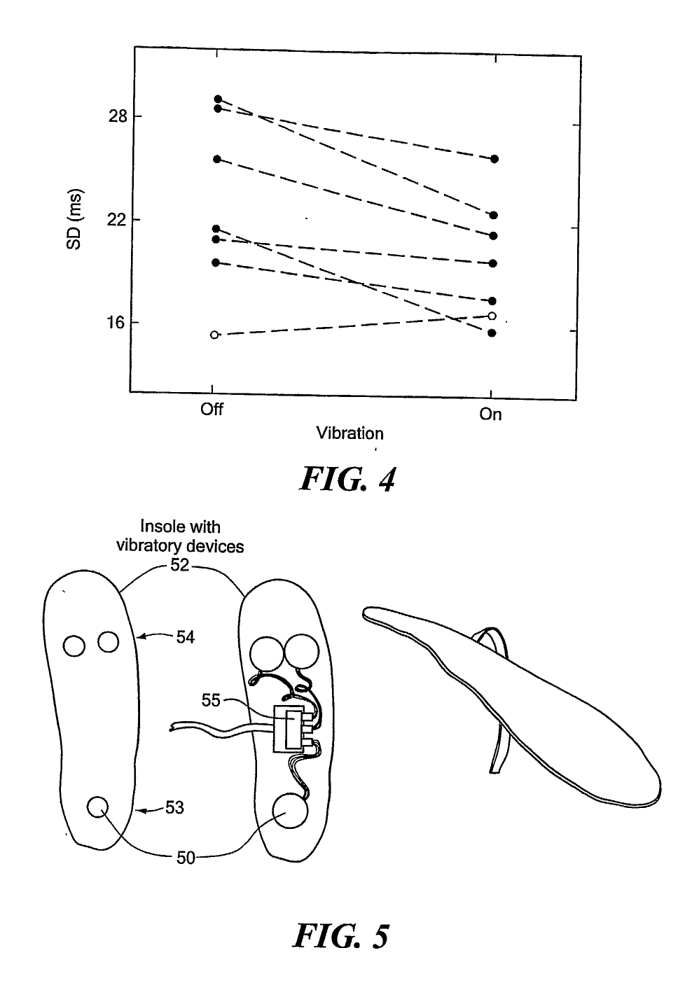

The vibratory stimulation decreased the standard deviation of the stride-to-stride interval (P<0.014) and CV (P<0.016) while there was no statistical difference in other monitored parameters such as walking distance, mean gait speed, mean step length, step duration. FIG. 4 shows standard deviation SD changing with vibration device 10 on and off for all subjects. The Standard deviation (SD) is determined based on the stride-to-stride interval during both cases of vibration off and on. Markers connected by a line represent one subject. The black squares represent subjects with a decrease of SD during vibration of the soles. The empty circles show a subject with increased SD during vibration stimulation.

The reduction of SD and CV was observed in all subjects except one. In that subject the baseline SD was the lowest (15.4 ms) of all subjects and it increased slightly to 16.7 ms during vibration.

The study indicates that vibratory stimulation of the soles that is phase-synchronized with the subject's step reduces gait variability in healthy volunteers. The physiological mechanisms underlying the effect of the vibratory stimulation are complex and it may include both spinal and cerebral circuits. Vibratory stimulation of a muscle tendon results in contraction of the muscle and relaxation of the antagonist muscle. The effect is much more pronounced in the contracted muscle as compared to the relaxed muscle, and it depends upon the vibratory frequency and length of the stimulation as well as being context-dependent. During standing, vibratory stimulation of the heel induces forward postural sway, stimulation of the forefoot results in the backward tilt, while simultaneous stimulation at both foot areas has no net effect. Based on the results, postural response to vibratory stimulation may be CNS mediated. Functional MRI studies showed activation of distinct brain structures during vibratory stimulation. Stimulation of digit tips activates the contralateral primary somatosensory cortex, bilateral secondary somatosensory cortex, the precentral gyrus, the posterior insula, the posterior parietal region and the posterior cingulate. PET studies showed that vibratory stimulation of the metacarpal joints activates ipsilateral sensory cortical areas and contralateral basal ganglia.

Vibratory device 10 was operated in a closed loop mode that results in amplification of the sensory feedback. In general, sensory feedback facilitates adjustment of limb trajectories during each step and participates in smoothing of walking irregularities. As such, vibratory stimulation of soles may modulate a motoneuron output in a similar way to that of electrical or mechanical stimulation of the foot.

The accumulated evidence appears to indicate that the stride time variability is a good measure of gait unsteadiness. The stride-to-stride variability is increased in the subjects with history of falls and it is an independent predictor of falling. The data suggest that the vibratory stimulation of the soles operating in the closed-loop mode may improve the gait profile by reducing the gait variability and therefore it might be useful for treatment of the gait and balance disorders. An advantage of the proposed approach is that it does not require a conscious attention to be effective. This might be important when there are reduced attentional resources available for the postural tasks such as in elderly subjects, in subjects with Alzheimer's disease or in Parkinson's disease.

Further testing to determine the contribution of impaired proprioception to abnormal gait in Parkinson's disease (PD) was undertaken. The above results suggest that vibratory stimulation might enhance the proprioceptive feedback. An additional study involving the present invention assessed the effects of step-synchronized vibration stimulation (S-VS) on gait in PD. S-VS was used in 8 PD subjects, 3 women and 5 men, with an age range of 44-79 years and using medication. In addition, 8 age-matched healthy subjects 5 women and 3 men were studied. Characteristics of the PD subjects are provided in Table II below.

TABLE II

| | | | Height | Weight | Duration of PD | | Total/motor | |
|---|---|---|---|---|---|---|---|---|
| No. | Gender | Age | (cm) | (kg) | (years) | Stage | UPDRS | LEDD |
| 1 | M | 63 | 180 | 86 | 13 | 2.5 | 18.5/10.5 | 1080 |
| 2 | F | 45 | 163 | 57 | 3 | 2.5 | 23/18 | 600 |
| 3 | F | 59 | 162 | 61 | 7 | 2.5 | 47/27 | 800 |
| 4 | M | 79 | 173 | 72 | 3 | 2.5 | 32/17 | 500 |
| 5 | M | 72 | 182 | 81 | 10 | 2.5 | 32/22 | 1650 |
| 6 | M | 44 | 170 | 86 | 2 | 2 | 32/18 | 150 |
| 7 | F | 70 | 167.5 | 59 | 6 | 2.5 | 16 | 300 |
| 8 | M | 59 | 172 | 73 | 4 | 2.5 | 18/27 | 0 |

Three vibratory stimulation devices (VD) were embedded into elastic insoles with one VS located below the heel and two VD located below the forefoot areas. The insoles were inserted in shoes used by the test subjects. The VD delivered the 70 Hz vibration pulse stimulus that was activated by the heel and forefoot touch and turned-off during the swing phase. Six minute hallway walking was studied with and without S-VS. Gait characteristics were measured using the force sensitive foot switches. In the PD group, S-VS increased walking speed (p<0.005), cadence (p<0.05), stride duration (p<0.005), stride length (p<0.005), and decreased stride variability (p<0.005). In the control group, S-VS decreased stride variability (p<0.05), while the other locomotion parameters remained unchanged. The augmented sensory feedback, synchronized with the stepping rhythm, improved gait characteristics in Parkinson's disease. S-VS thus appears to improve gait steadiness by reducing stride variability in PD subjects.

Clinical and demographic characteristics of the PD subjects and the eight healthy subjects are summarized in Table III below. The eight healthy subjects included 5 women and 3 men, with an age range of 45-76 years, a weight range of 67-84 kg and a height range of 157-185 cm. The healthy subjects were not treated for any systemic disease.

TABLE III

| | PD subjects | | | | Control subjects | | | |
|---|---|---|---|---|---|---|---|---|
| Locomotion | S-VS− | | S-VS+ | | S-VS− | | S-VS+ | |
| parameters | Mean | SD | Mean | SD | Mean | SD | Mean | SD |
| Velocity (m/s) | 1.02 | 0.20 | 1.11 ** | 0.20 | 1.25 | 0.15 | 1.32 | 0.17 * |
| Cadence (steps/min) | 104.9 | 8.9 | 109.2 * | 10.2 | 110.9 | 4.9 | 112 | 5.7 NS |
| Stride duration (ms) | 1149.6 | 90.9 | 1107 ** | 100.9 | 1112.9 | 99.0 | 1103.2 | 105.4 NS |
| Stride length (m) | 1.17 | 0.24 | 1.24 ** | 0.26 | 1.4 | 0.16 | 1.37 | 0.19 NS |
| Stride CV (%) | 5.36 | 3.08 | 4.4 ** | 2.69 | 2.8 | 0.4 | 2.3 | 0.5 * |
| Stance duration (ms) | 730.8 | 79.7 | 679.3 * | 90.2 | 653.8 | 66.19 | 654.95 | 69.9 NS |
| Stance CV (%) | 1.99 | 1.0 | 1.6 * | 0.8 | 1.29 | 0.63 | 0.99 | 0.30 NS |
| Stance (%) | 63.54 | 4.04 | 61.3 NS | 5.1 | 58.9 | 6.1 | 59.6 | 6.6 NS |
| Swing duration (ms) | 418.8 | 54.8 | 427.7 * | 64.6 | 446.6 | 83.36 | 435.8 | 85.8 NS |
| Swing CV (%) | 1.86 | 1.04 | 1.6 * | 0.8 | 0.95 | 0.35 | 0.88 | 0.45 NS |
| Double support | 156.0 | 51.05 | 134.6 NS | 42.76 | 115.6 | 25.7 | 112.1 | 45.7 NS |
| duration (ms) | | | | | | | | |
| Double support | 13.5 | 4.03 | 12.1 NS | 3.49 | 10.5 | 2.78 | 10.6 | 4.19 NS |
| percent (%) | | | | | | | | |
| Double support CV (%) | 2.78 | 1.6 | 2.77 NS | 1.7 | 0.72 | 0.25 | 0.97 | 0.87 NS |

The subjects were included if they were able to walk for 6 minutes at self-paced speed without interruptions. The subjects were excluded if they had medical history of peripheral polyneuropathy, hypertension, stroke, CNS or gait disorders, diabetes or were using walking aids.

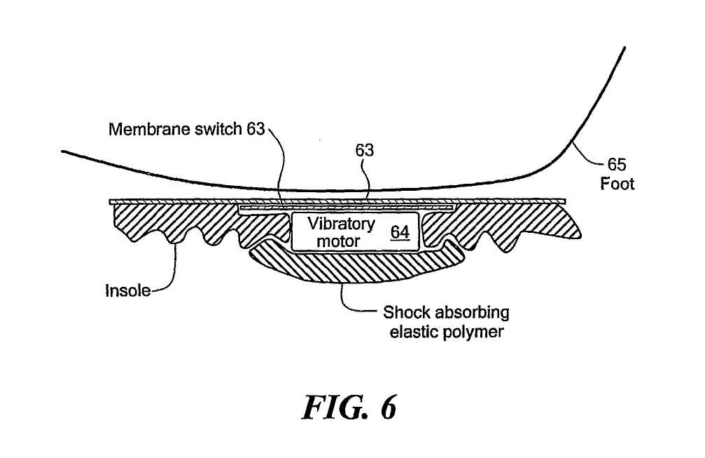

Referring to FIG. 5, a wearable, battery operated vibratory device 50 delivers a vibration stimulus to the soles that is synchronized with the step. Three devices 50 are embedded into each insole 52, one below a heel 53, and two below a forefoot 54. Devices 50 sense pressure at the sole and delivers a vibration stimulus upon heel and forefoot touch. The vibration stimulation is turned off during a swing phase of gait. Device 50 delivers supra-threshold stimulation that is perceived as a light vibration at the soles. Vibration intensity is comparable to the portable devices, e.g. cell phones and beepers, operating in a vibration mode. Device 50 is mounted on shoe insole 52 for insertion in a shoe of a subject. Device 50 may use a miniature vibrating disk motor 64 (FIG. 6) such as an Optec 2890W11 motor from OPTEC Co. Ltd., Japan, vibrating at a frequency of 70 Hz and operating at 1.3 Volts. Device 50 consists of a vibration disk motor 64 with a diameter of 18 mm and a membrane switch 63 glued on a top of motor 64, with a resulting thickness of approximately 5.0 mm and weight of approximately 5 grams.

Referring to FIG. 6, a foot sensor 62 that provides a feedback to device 50 is based on an industrial membrane switch 63 that turns on with the application of a force of 350 g. Foot sensor 62 is attached on top of a vibration motor enclosure 65. The resulting vibratory unit is embedded in elastic insoles 52 using a shock-absorbing elastic silicon polymer. The device operates in a simple closed loop mode and provides input and output signals for interfacing with a real-time microcontroller 55 that can be used to deliver vibratory stimulation in a variety of preprogrammed patterns.

Six minute walking trials including straight segments and typically 4-6 turns at 180 degrees were carried out. Parkinson's disease group had slower walking speed (p<0.05) and higher coefficient of variation of the stride interval (p<0.05) compared to control subjects. There was no significant difference in other locomotion parameters between the Parkinson's and control subjects.

The vibratory device was well tolerated. The most common experience was an increased awareness of the foot placement on the floor. There was no significant difference in locomotion parameters including the walking speed and the coefficient of variation of the stride interval between the PD and control groups during the S-VS walking.

In the control group, the coefficient of variation of the stride interval was reduced by 22% (p<0.05) during the S-VS walking compared to walking without the S-VS. Other locomotion parameters were not significantly altered by the S-VS in the control group.

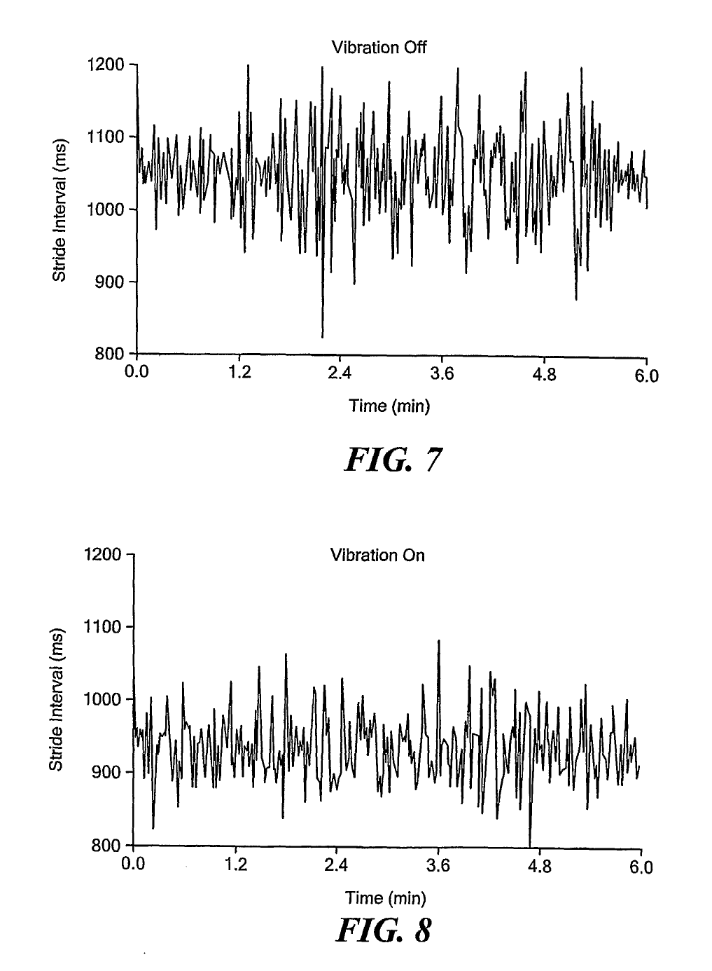

Results for the Parkinson's disease group are illustrated in FIGS. 7, 8, where examples of stride intervals obtained during walking with and without the S-VS in a PD subject are shown. The S-VS significantly increased the walking speed, cadence, the stride duration and its length, the swing duration and decreased the stance duration, as indicated in Table III. The coefficients of variation of the stride intervals, stance duration, and the swing duration were decreased during the S-VS walking. The stance percent of the step, double support duration and double support percent of the step and coefficient of variation of the double support were not affected. Two PD subjects with a history of falls, subjects 2 and 3 in Table II, had the highest baseline coefficient of variation of the stride. In these subjects the S-VS improved the CV of stride interval by 20.9% and 32% respectively.

This study shows that vibration stimulation of the soles synchronized with the step improves gait characteristics in Parkinson's disease subjects. The vibration stimulation increased the walking speed and the stride length, and decreased the stride variability in the PD group. The stride variability also decreased in the control group. Locomotor patterns are regulated through the feedback loops among the proprioceptive receptors and central motor pattern generators. Sensory feedback is used for gait stability by providing inputs to the central pattern generators that can rapidly adapt to external perturbations and correct programming errors in intended movement direction, force and execution. The accumulated evidence provides that the stride interval variability is an important measure of gait unsteadiness, motor performance and activities of daily living. The stride interval variability is increased in the subjects with history of falls, and it is an independent predictor of falling. Improvement of several locomotion parameters by the enhancement of sensory feedback using vibration stimulation suggested that abnormal proprioception may be one of the mechanisms underlying gait abnormalities in Parkinson's disease. The step-synchronized vibration may stabilize gait in PD subjects by reducing the stride interval variability. Vibration stimulation improved gait in PD subjects, in addition to dopaminergic medications.

Physiological mechanisms by which the vibration stimulation modulates gait involve both peripheral and central circuits. The plantar foot mechanoreceptors and the Golgi tendon organs of the antigravity muscles are the main load-proprioreceptors. The vibration device operated in a simple closed loop mode, so that the sensory feedback enhancement of the plantar foot was synchronized with the step. Vibration stimulation of a muscle tendon results in contraction of the underlying muscle and relaxation of the antagonist muscle. During standing, vibration stimulation of the heel induced the forward postural sway, stimulation of the forefoot resulted in the backward tilt, while simultaneous stimulation at both areas did not affect balance or resulted in minor oscillations. Therefore, vibration stimulation of the plantar foot may modulate the motoneuron outputs similarly to the electrical or mechanical stimulation, by facilitating the adjustment of limb trajectories during each step and by reducing gait variability. Vibration stimulation at the heel and forefoot that is synchronized with the step-phase may have differential effects on muscle activation during walking. During walking, the antigravity extensor muscles are controlled by the spinal loops, whereas flexor muscles, including the tibialis anterior, are predominantly modulated by brain circuits. The tibialis anterior is activated during the heel strike and push-off phase during normal walking. Inappropriate timing and reduced contraction of the tibialis anterior affects dorsiflection and contributes to a shuffling, parkinsonian gait. The posterior VD device that delivers stimulation upon the heel strike may enhance the tibialis anterior activation and ankle dorsiflection. This is followed by the activation of the anterior VDs that may facilitate proprioceptive-specific antagonist muscle contraction during the push off phase. The vibration stimulation at the heel and forefoot may have differential effects and facilitate motor output during the gait cycle. The basal ganglia contribute a primary control to stride length, while the spinal and brainstem circuits control the cadence. Therefore, synchronization of vibration stimulation with the gait phase may improve timing and variability of the gait cycle by activating different pathways, including spinal circuitry and basal ganglia. Functional MRI studies that showed activation of a distinct brain structures during the vibratory stimulation support these findings. Stimulation of fingertips activates the contralateral primary somatosensory cortex, bilateral secondary somatosensory cortex, the precentral gyrus, the posterior insula, the posterior parietal region and the posterior cingulate. PET studies showed that vibratory stimulation of the metacarpal joints activates ipsilateral sensory cortical areas and contralateral basal ganglia.

The vibration stimulus used in this study was supra-threshold that prevented blinding of the study participants. The remote possibility may exist that increased attention to gait may affect the stride length. Moreover, the efficacy of attentional strategies for elderly and Parkinson's disease patients during the postural tasks is limited. However, the significant stride length prolongation using S-VS was found in the PD group rather than in the control group in our study, suggesting that the increased attention is not likely a solely factor for observed gait improvement using S-VS. The effects of vibration on balance support the notion that the S-VS does not require conscious attention to be effective. The S-VS was assessed in an acute setting.

The data suggests that the present invention is useful in the treatment of the walking and balance abnormalities. Step-synchronized supra-threshold vibration stimulation improved gait characteristics in Parkinson's disease. Vibration stimulation enhanced the proprioceptive inputs supporting the hypothesis that abnormal proprioception may contribute to gait abnormalities in Parkinson's disease. The device and method of the present invention, which provides vibratory stimulation that is synchronized with step, also provides a tool to evaluate the complex dynamic of walking.

Although the present invention has been described in relation to particular embodiments thereof, other variations and modifications and other uses will become apparent to those skilled in the art from the description. It is intended therefore, that the present invention not be limited not by the specific disclosure herein, but to be given the full scope indicated by the appended claims.

What is claimed is:

1. A stimulatory device for a foot of a subject, comprising:
a vibrational source associated with an article of footwear to the foot of the subject to provide stimulation to the foot through vibrational stimulation;
a sensor coupled to the source and operable to modify output characteristics of the source; and
the sensor being operable to detect a step of the subject.

2. The device according to claim 1, wherein the sensor is located in a heel region of the article.

3. The device according to claim 1, wherein the sensor is operable to cause the source to provide stimulation prior to a step detection event.

4. The device according to claim 1, wherein the device may be formed in an insole, to permit insertion of the device in the article with the insertion of the insole.

5. The device according to claim 1, wherein the sensor device is operable to turn the vibrational source on and off according to foot pressure.

6. The device according to claim 1, further comprising a source controller interposed between the sensor and the vibrational source and operable to receive control inputs from the sensor device and provide control outputs to the vibrational source.

7. The device according to claim 6, wherein the controller is operable to provide magnitude control to vary magnitude of the vibration from the vibrational source.

8. The device according to claim 6, wherein the sensor device is operable to indicate proportional force to permit variation in control of the vibrational source.

9. The device according to claim 6, wherein the controller further comprises a processor for running an algorithm related to control of the vibrational source based on input information from the sensor device.

10. An item of foot apparel including the device of claim 1.

11. An item of foot apparel including the device of claim 6.

12. A method for stimulating a subject's foot during periods of ambulatory activity, comprising:
sensing a force indication related to movement of the foot of the subject;
controlling a stimulation device coupled to the foot of the subject to stimulate the foot of the subject based on sensed force indications; and
applying stimulation to the foot of the subject over an interval that includes the foot being supported by an ambulatory support and preventing application of the stimulation during an interval that includes the foot being unsupported by an ambulatory support.

13. The device according to claim 6, wherein the sensor is located in a heel region of the article.

14. The device according to claim 6, wherein the controller is operable to cause the source to provide stimulation prior to a step detection event.

15. The device according to claim 6, wherein the device may be formed in an insole, to permit insertion of the device in the article with the insertion of the insole.

16. The method according to claim 12, further comprising operating the stimulation based on an algorithm supplied to a processor coupled to the stimulator in conjunction with a sensed force input.

17. The method according to claim 12, further comprising varying a magnitude of the stimulation in proportion to a sensed force input.
